(19) United States
(12) Patent Application Publication
(10) Pub. No.: US 2005/0050824 A1
(43) Pub. Date: Mar. 10, 2005

(54) Garage door cladding system and method

(76) Inventor: William Kent Warner III, Monument, CO (US)

Correspondence Address: LAW OFFICE OF DALE B. HALLING, 24 s. WEBER ST., SUITE 311, COLORADO SPRINGS, CO, 80903, US

(21) Appl. No.: 10/778,472

(22) Filed: Feb. 13, 2004

Related U.S. Application Data
(60) Provisional application No. 60/496,079, filed on Aug. 18, 2003.

(51) Int. Cl. E04C 1/00; B44F 9/00

(52) U.S. Cl. 52/313; 52/309.8

(57) ABSTRACT

A door cladding system has a number of composite panels with a wood grain surface. An attachment system holds the composite panels onto a front surface of a door.

### RELATED APPLICATIONS

The present invention claims priority on provisional patent application, Ser. No. 60/496,079, filed on Oct. 15, 2003, entitled “Transforma Door”.

### FIELD OF THE INVENTION

The present invention relates generally to the field of doors and more particularly to the a garage door cladding system and method.

### BACKGROUND OF THE INVENTION

Most houses have metal garage doors. These doors do not look nearly as nice as wood garage doors. However, wood garage doors are expensive, heavy and require a considerable amount of maintenance to keep up their appearance. As a result, you usually see wood garage doors on expensive houses only. Even when a home owner decides that they want to exchange their metal garage door for a wood garage door, they have to remove the metal door, install a strong rail and support system, a new stronger counter balance spring system and a new garage door opener. This is enough to discourage most home owners from undertaking this task.

Thus there exists a need for a system that converts a metal garage door into a wood look garage door, that is light and has less maintenance than a standard wood garage door.

### SUMMARY OF THE INVENTION

A door cladding system that overcomes these and other problems has a number of composite panels with a wood grain surface. An attachment system holds the composite panels onto a front surface of a door. The door may be a garage door. The composite panels may be formed of a plastic composite. In one embodiment, the composite panels are formed using a long fiber technology. The composite panels may have a coating. In another embodiment, the composite panels have a paint covered surface.

In one embodiment, the attachment system includes a glue. The attachment system may include a fastener. In another embodiment, the attachment system includes a bracket.

A method of cladding a garage door includes the steps of creating a foamed composite plastic panel. Next, the foamed composite plastic panel is affixed to the garage door. In one embodiment, a long fiber technology is used to create the foamed composite plastic panel. A mold may have a wood grain surface.

In another embodiment, paint is placed in the mold. Next, a rigid urethane foam is placed in the mold.

In one embodiment, a counterbalance is adjusted for the garage door. A stain is placed over an exterior surface of the foamed composite plastic panel.

In one embodiment, a glue is placed on a back side of the foamed composite plastic panel. The foamed composite plastic panel is then placed against a panel of the garage door. A physical fastener may be inserted into the foamed composite plastic panel and the garage door.

In one embodiment, a kit for cladding a garage door includes a number of foamed plastic composite panels each having a wood grain surface. The kit also has an attachment system and a set of instructions for using the attachment system to attach the panels to the garage door. In one embodiment, the wood grain surface has a pigment embedded in the surface. In another embodiment, the foamed plastic composite panels are formed using a long fiber technology and a rigid plastic. The attachment system may permanently affix the foamed plastic panels to the garage door. The attachment system may include glue.

### BRIEF DESCRIPTION OF THE DRAWINGS

FIG. 1 is a sketch of a garage door with a panel of a door cladding system attached in accordance with one embodiment of the invention;

FIG. 2 is a cross section of a garage door with the garage door cladding system applied in accordance with one embodiment of the invention;

FIG. 3 is a cross section of a mold used to form a garage door cladding system in accordance with one embodiment of the invention; and

FIG. 4 is a kit for cladding a garage door in accordance with one embodiment of the invention.

### DETAILED DESCRIPTION OF THE DRAWINGS

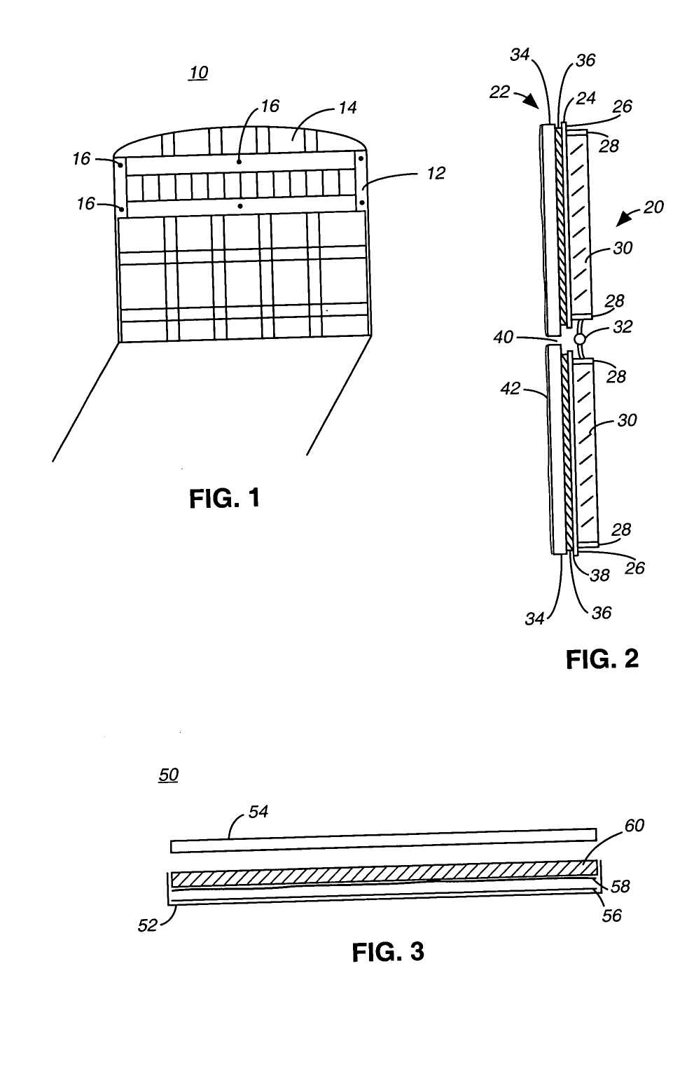

A garage door cladding system and method provides the beauty of wood and more particularly stained wood, with substantially less maintenance and weight associated with standard wood door garages. FIG. 1 is a sketch of a garage door 10 with a panel 12 of a door cladding system attached in accordance with one embodiment of the invention. The garage door is a standard steel garage door 14. It is shown with a plastic composite panel 12 attached. The panel 12 is attached using glue and finishing nails 16. Other fasteners may also be used, such as screws, magnets, rivets. The panels may be attached using magnets, or magnets and glue, or may use magnets and mating flanges. The panels 12 may be made using reaction injection molding (RIM) technology. In order for the panels 12 to be light weight they are made using a foamed plastic technology. The plastic is a rigid urethane. In one embodiment, the panels are formed with long fiber technology, which is type of RIM technology. Long fiber technology combines the foamed plastic with fibers, such as fiberglass fibers, to provide additional structural integrity to the plastic. By foaming the plastic and having the panels be about 0.125 inches thick, the weight of the panels is around five pounds. It takes between eight and ten panels to cover a one car garage door or sixteen to twenty panels to cover a two car garage. As a result, the total weight of the panels for a one car garage door is about forty to fifty pounds. A standard wood door can easily weigh over 1000 pounds.

FIG. 2 is a cross section of a garage door 20 with the garage door cladding system 22 applied in accordance with one embodiment of the invention. The steel garage door 20 has a steel skin 24 made up of a number of panels 26. Each panel 26 may have lips 28 for holding an insulating material 30, such as foam. Hinges 32 are coupled the steel panels 26. A composite plastic panel 34 is applied to each steel panel 26 by glue 36 to a front surface 38 of the steel door. The back surface 40 the panel 34 is applied to the glue. The front surface 42 of the panel 34 has a wood grain surface. Fasteners may be used in addition to the glue 36 to permanently affix the panels 34 to the steel door 20. Once the panels 34 are affixed to the door 20, a wood stain may be surface 42. This enhances the stained wood look of the garage door. Once the panels 34 have been attached it may also be necessary to adjust the counterbalance of the garage door. Commonly tension springs are used to counterbalance the weight of a garage door. The tension of the existing springs may be adjusted or stronger springs may be installed.

It is common on steel garage doors to have weather stripping around the edges of the garage door. It is possible because of how thin the panels 34 are that, without adjustment, the panels will also fit under the weather stripping. If the panels do not fit nicely under the weather stripping, the garage door's rails may be adjusted slightly so that the panels do fit nicely under the weather stripping. In one embodiment, the weather stripping may be replaced with wood framing or wood like framing.

FIG. 3 is a cross section of a mold 50 used to form a garage door cladding system in accordance with one embodiment of the invention. The mold 50 has a lower portion 52 and a lid 54. One surface 56 of the mold 50 has a wood grain surface. A layer of paint or a coating or a pigment 58 is placed against the wood grain surface 56. If paint is used, the paint may be allowed to flash off before the foamed plastic 60 is inserted into the mold 50. Once the foamed plastic 60 is inserted into the mold 50 the lid 54 may be applied. In another embodiment, the lid 54 has a orifice through which the foamed plastic is applied. These panels may be foamed using RIM (reaction injection molding), SRIM (Structural RIM), RRIM (Reinforced RIM), SMC (Structural Molding Compound), LFT (Long Fiber Technology), rubber etc.

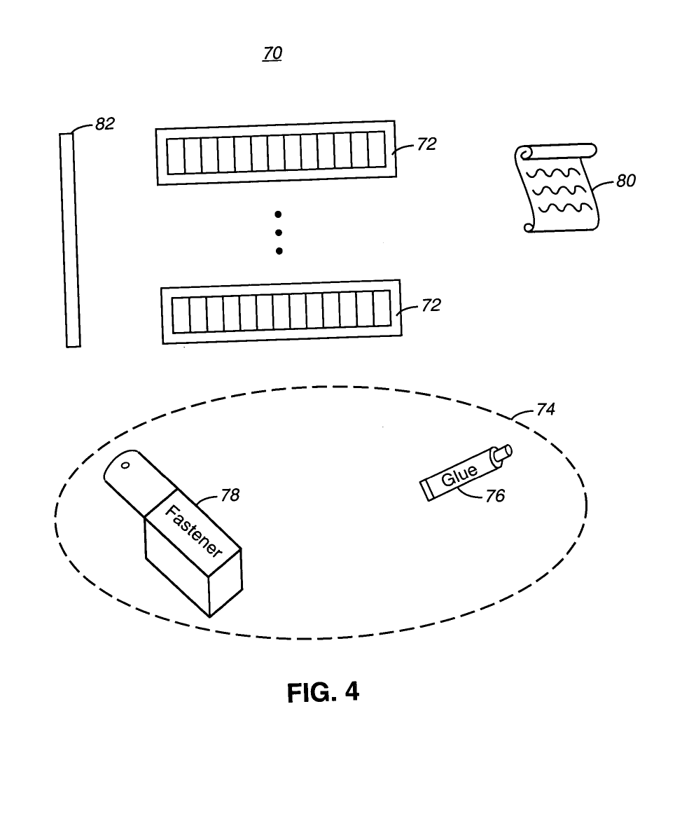

FIG. 4 is a kit 70 for cladding a garage door in accordance with one embodiment of the invention. The kit 70 includes a plurality of plastic composite panels 72 that have the look of wood. The kit 70 also includes an attachment system 74. The attachment system 74 in one embodiment includes glue 76 and fasteners 78, such as finishing nails. The attachment system 74 may permanently attach the panels 72 to a garage door. The kit also includes instructions 80 that explain how to use the attachment system 74 to attach the panels 72 to a garage door. In one embodiment, the kit 70 may include slats 82 that provide the carriage door look or other facade. Since the panels 72 and slats 82 are formed of a plastic composite, they are almost completely weather resistant and indestructible. This almost eliminates the need for maintenance. In addition, the panels are considerably lighter than a wood garage door. This reduces the cost of the garage door mechanisms, such as rails, brackets and garage door openers.

Note that while the invention has been described with respect to a garage door, other doors or objects may also be clad using this invention.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

1. A door cladding system, comprising:
a plurality of composite panels having a wood grain surface;
an attachment system for holding each of the plurality of composite panels onto a front surface of a door.

2. The system of claim 1, wherein the door is a garage door.

3. The system of claim 1, wherein the plurality composite panels are formed of a plastic composite.

4. The system of claim 1, wherein the plurality of composite panels are formed using a long fiber technology.

5. The system of claim 4, wherein the plurality of composite panels have a coating.

6. The system of claim 4, wherein the plurality of composite panels have a paint covered surface.

7. The system of claim 1, wherein the attachment system includes a glue.

8. The system of claim 7, wherein the attachment system further includes a fastener.

9. The system of claim 1, wherein the attachment system includes a bracket.

10. A method of cladding a garage door, comprising the steps of:
(a) creating a foamed composite plastic panel; and
(b) affixing the foamed composite plastic panel to the garage door.

11. The method of claim 10, wherein the step (a) further includes the steps of:
(a1) using a long fiber technology to create the foamed composite plastic panel;
(a2) using a mold having a wood grain surface.

12. The method of claim 10, wherein step (a) further includes the steps of:
(a1) placing a paint in a mold;
(a2) placing a rigid urethane foam in the mold.

13. The method of claim 10, further including the steps of:
(c) adjusting a counterbalance for the garage door;
(d) placing a stain over an exterior surface of the foamed composite plastic panel.

14. The method of claim 10, wherein step (b) further includes the steps of:
(b1) placing a glue on a back side of the foamed composite plastic panel;
(b2) placing the foamed composite plastic panel against a panel of the garage door.

15. The method of claim 14, further including the step of:
(b3) inserting a physical fastener into the foamed composite plastic panel and the garage door.

16. A kit for cladding a garage door, comprising:
a plurality of foamed plastic composite panels having a wood grain surface;
an attachment system; and
a set of instructions explaining how the attachment system is used to attach the plurality of foamed plastic composite panels to the garage door.

17. The kit of claim 16, wherein the wood grain surface has a pigment embedded in the surface.

18. The kit of claim 16, wherein the foamed plastic composite panels are formed using a long fiber technology and a rigid plastic.

19. The kit of claim 16, wherein the attachment system permanently affixes the plurality of foamed plastic panels to the garage door.

20. The kit of claim 19, wherein the attachment system includes a glue.
